(19) United States
(12) Patent Application Publication
(10) Pub. No.: US 2013/0314298 A1
(43) Pub. Date: Nov. 28, 2013

(54) Wearable Device

(71) Applicant: Lance Alex Stokes, Plano, TX (US)

(72) Inventor: Lance Alex Stokes, Plano, TX (US)

(73) Assignee: COTTON SNAPS, INC., Dallas, TX (US)

(21) Appl. No.: 13/608,865

(22) Filed: Sep. 10, 2012

Related U.S. Application Data
(60) Provisional application No. 61/652,321, filed on May 28, 2012.

(51) Int. Cl. G09G 5/00

(52) U.S. Cl. 345/1.1

(57) ABSTRACT

A wearable device having a first object and a retention system, the retention system having a first link comprising a first interface and a second interface and wherein the first interface is configured to selectively mechanically couple the first link to the first object and wherein the second interface is configured to selectively join the first object and the retention system in a loop via a magnetic connection.

### CROSS-REFERENCE TO RELATED APPLICATIONS

The present application claims priority to U.S. Provisional Patent Application No. 61/652,321, filed on May 28, 2012 by Lance Alex Stokes, entitled “Strap for Holding/Retaining Glasses” which is incorporated by reference herein as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Some wearable items, such as eyeglasses, may undesirably become dislodged from a worn position. In some cases, wearable items that become dislodged from the worn position may impact a ground surface and/or become damaged as a result of having become dislodged from the worn position.

### SUMMARY

In some embodiments of the disclosure a wearable device is provided that comprises a first object and a retention system comprising a first link comprising a first interface and a second interface, wherein the first interface is configured to selectively mechanically couple the first link to the first object and wherein the second interface is configured to selectively join the first object and the retention system in a loop via a magnetic connection.

In other embodiments of the disclosure, a retention system is provided that comprises a first link comprising a mechanical interface and a magnetic interface and a second link comprising a mechanical interface and a magnetic interface wherein the mechanical interface of the first link and the mechanical interface of the second link are each configured for selective connection to a wearable device and wherein the magnetic interfaces are configured for selective connection to each other.

In yet other embodiments of the disclosure, a wearable device is provided that comprises an eyeglasses frame, a first link, and a second link. The eyeglasses frame comprises a first arm and a second arm. The first link comprises a first mechanical interface comprising a first elastic receiver, the first mechanical interface being configured for mechanically coupling the first link to the first arm by receiving the first arm into the first elastic receiver, and a first magnetic interface comprising a first magnet. The second link comprises a second mechanical interface comprising a second elastic receiver, the second mechanical interface being configured for mechanically coupling the second link to the second arm by receiving the second arm into the second elastic receiver, and a second magnetic interface comprising a second magnet, the second magnetic interface being configured for magnetically coupling the second link to the first link by magnetically connecting the second magnet to the first magnet.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is an oblique top-right-front view of a wearable device comprising a retention system according to an embodiment of the disclosure;

FIG. 2 is an orthogonal top view of the retention system of FIG. 1;

FIG. 3 is a cut-away orthogonal top view of a first interface of the retention system of FIG. 1;

FIG. 4 is a cut-away orthogonal top view of two second interfaces of the retention system of FIG. 1;

FIG. 5 is a cut-away orthogonal top view of a portion of a retention system according to an alternative embodiment of the disclosure;

FIG. 6 is a cut-away orthogonal top view of a portion of a retention system according to another alternative embodiment of the disclosure;

FIG. 7 is an orthogonal right view of a retention system according to another alternative embodiment of the disclosure;

FIG. 8 is an orthogonal top view of a retention system according to another alternative embodiment of the disclosure;

FIG. 9 is an orthogonal top view of a retention system according to another alternative embodiment of the disclosure;

FIG. 10 is a cut-away orthogonal top view of a retention system according to another alternative embodiment of the disclosure;

FIG. 11 is an orthogonal top view of a portion of a retention system according to another alternative embodiment of the disclosure;

FIG. 12 is an orthogonal left schematic view of a portion of a retention system according to another alternative embodiment of the disclosure;

FIG. 13 is an orthogonal left view of a portion of a retention system according to another alternative embodiment of the disclosure; and

FIG. 14 is a cut-away orthogonal top view of a retention system according to another alternative embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the disclosed designs and implementations illustrated and described herein, but may be modified within the scope of the appended claims along with their full scope of equivalents.

In some cases, it may be desirable to provide a wearable device, such as a wearable device comprising eyeglasses and a retention system for selectively retaining the eyeglasses to selectively maintain the wearable device in worn position. In some cases, the worn position may comprise suspending the eyeglasses from the neck of a wearer of the wearable device using the retention system. In other cases, the retention system may be selectively configured to maintain the eyeglasses in a visually assistive position relative to the wearer of the wearable device. In some cases, it may be desirable to provide a retention system comprising a magnetic interface configured to selectively maintain the wearable device in a worn position.

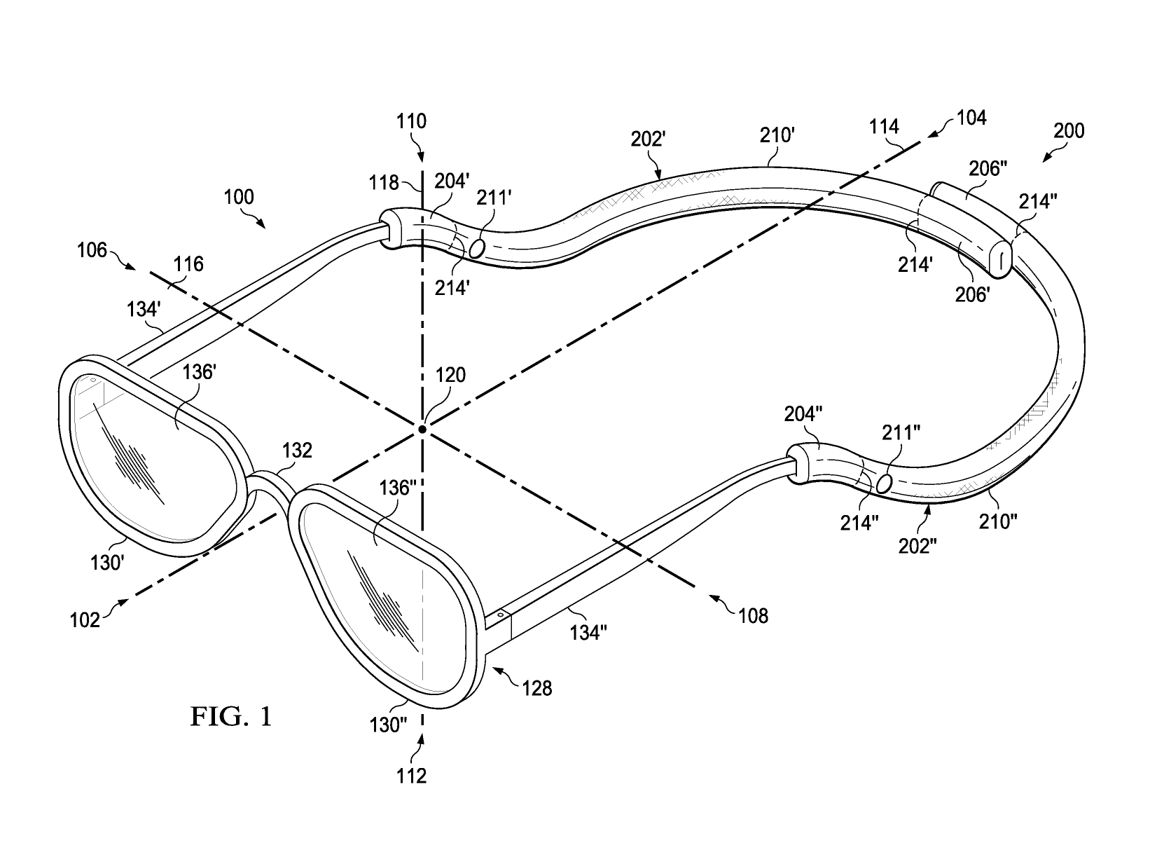

Referring to FIGS. 1-4, a wearable device 100 according to an embodiment of the disclosure is shown. Wearable device 100 may be described as generally comprising a front 102, rear 104, left 106, right 108, top 110, and bottom 112 and the following description and associated drawings may generally utilize directional indications to assist in identifying the directional orientation of the wearable device 100 and/or components of the wearable device 100 without the requirement that such an indication is an absolute identification of a directional extent of the wearable device 100. In other words, the above-described directional indications are intended to generally clarify orientations of the components of the wearable device 100 relative to each other and to provide context to the associated figures. The same directional indicators are utilized in the discussion and associated figures that comprise the wearable device 100 and/or components of the wearable device 100 to provide a consistent frame of reference throughout the disclosure.

The wearable device 100 further comprises a longitudinal axis 114, a lateral axis 116, and a vertical axis 118. The lateral axis 116 generally extends longitudinally in a front-rear direction relative to the wearable device 100. The longitudinal axis 114 generally extends laterally in a left-right direction relative to the wearable device 100. The vertical axis 118 generally extends vertically in a top-bottom direction relative to the wearable device 100. The longitudinal axis 114, lateral axis 116, and vertical axis 118 intersect each other at an origin 120 and may generally be described as defining a three dimensional Cartesian coordinate system. The wearable device 100 further comprises a lateral bisection plane 122, a longitudinal bisection plane 124, and a vertical bisection plane 126. The lateral bisection plane 122 is generally coincident with the longitudinal axis 114 and the vertical axis 118. The longitudinal bisection plane 124 is generally coincident with the lateral axis 116 and the vertical axis 118. The vertical bisection plane 126 is generally coincident with the lateral axis 116 and longitudinal axis 114.

While the axes 114, 116, and 118 and bisection planes 122, 124, and 126 are generally shown as being located with specificity relative to the wearable device 100, the location of the origin 120 relative to the wearable device 100 and the orientation of the axes 114, 116, and 118 relative to the wearable device 100 may be described differently without impact to the functionality of the wearable device 100 and/or the components of the wearable device 100 disclosed herein. In other words, unless otherwise noted herein, the defined orientations of the axes 114, 116, and 118 and bisection planes 122, 124, and 126 are provided as a frame of reference against which the wearable device 100 and the components of the wearable device 100 may be consistently described.

Referring now to FIG. 1, an oblique top-right-front view of the wearable device 100 is shown. The wearable device 100 generally comprises an eyeglasses frame 128 comprising a rim 130, a bridge 132, arms 134, and lenses 136. The wearable device 100 further comprises a retention system 200 configured to selectively link the arms 134 to each other, thereby selectively providing a loop comprised of the eyeglasses frame 128 and the retention system 200 that may encircle a neck of a wearer of the wearable device. In alternative embodiments, the eyeglasses frame 128 may be differently shaped. Regardless the shape, size, and/or location of the eyeglasses frame 128, the eyeglasses frame 128 comprises at least two connection interfaces, such as the distal ends of the arms 134, to which the retention system 200 may be selectively connected.

The retention system 200 may be referred to as a neck strap system and/or other hanging support system. The retention system 200 generally comprises at least one link 202. In this embodiment, the retention system 200 comprises two links 202′, 202″ connected to the support eyeglasses frame 128. As explained herein, in some embodiments, the similarities between the links 202 of a retention system 200, such as links 202′, 202″, physically, spatially, and/or kinematically, allow for the use of the reference number modifier,′, or a “prime symbol,” to denote a first and/or left side system or component while the use of the reference number modifier, ″, or a “double prime symbol,” denotes a second and/or right side system or component. The links 202′, 202″ may generally comprise components configured to enable selective attachment to the eyeglasses frame 128 and to each other. In the embodiment shown, the link 202″ comprises substantially identical components to the components of the link 202′. Accordingly, as a result of the generally mirror image positioning of some components of the links 202′, 202″ about the lateral bisection plane 122, in the embodiment shown, the link 202″ may be substantially kinematically complementary to the link 202′. For example, in the embodiment shown, any of the components of the link 202′ may be supplanted for use of the related component of the link 202″ and with appropriate orientation relative to the lateral bisection plane 122, the supplanted component may be utilized without changing the shape, size, structure, functionality, and/or kinematic behavior of the link 202″.

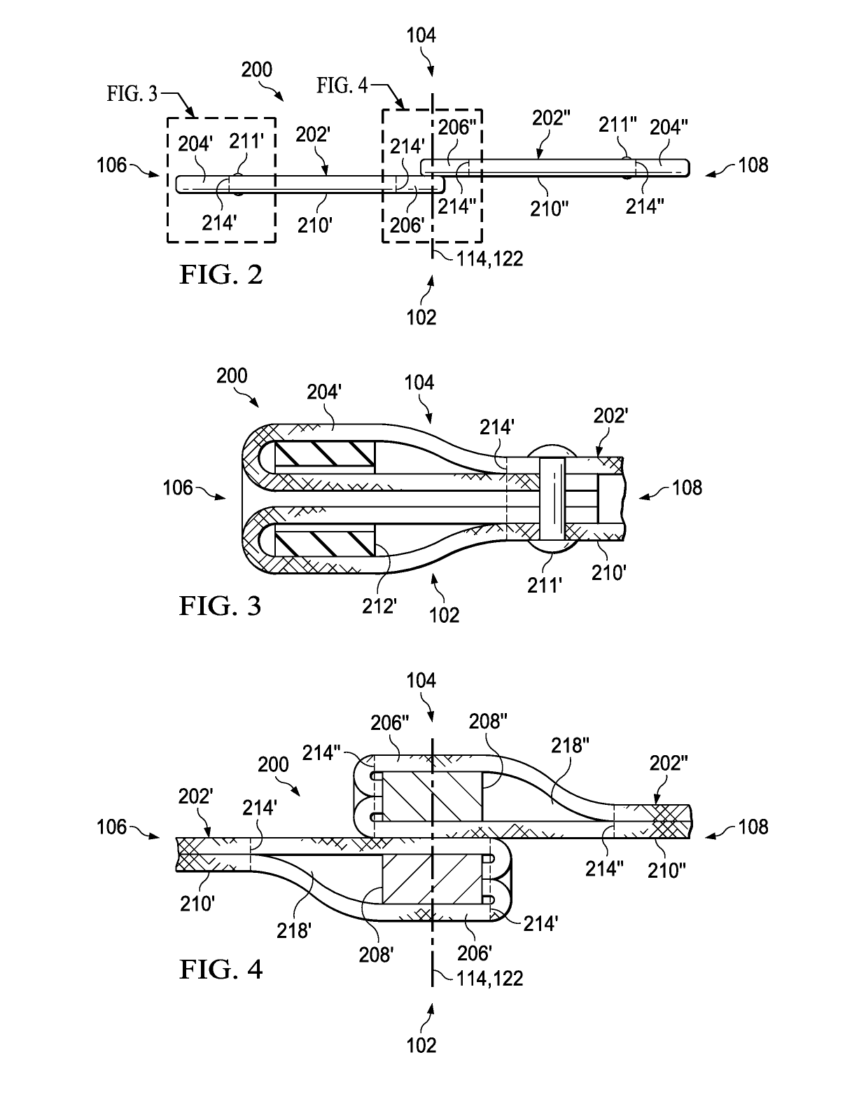

Still referring to FIGS. 1 and 2, the each link 202 comprises a first interface 204 and a second interface 206. In this embodiment, the first interface 204 is configured to selectively connect the link 202 to the eyeglasses frame 128 while the second interfaces 206 are configured to selectively connect to each other. In some embodiments, at least one of the first interface 204 and the second interface comprise a component configured for use in a magnetic connection. In this embodiment, at least one of the second interfaces 206 comprises a magnet 208. Throughout this disclosure, it will be appreciated that to the extent that magnetic connections are disclosed, the utilization of magnetic poles, specifically the attractive nature of opposing magnetic poles, may be utilized to promote a magnetic connection between magnets. Similarly, it will be appreciated that to the extent that a magnet is disclosed for utilization in a magnetic connection, an object with sufficiently ferrous content may be utilized instead of a second magnet. Still further, it will be appreciated that magnets and/or sufficiently ferrous objects may be chained together with and/or without spatial offsets between them to achieve a single and/or combined magnetic connection.

In this embodiment, the links 202 generally comprise a flexible tube 210 that carries the first interface 204 and second interface 206. In this embodiment, the first interface 204 and the second interface 206 are disposed at opposing ends of the tube 210. However, in alternative embodiments, one or both of the first interface 204 and second interface 206 may be offset from the ends of the tube 210. In this embodiment, the tube 210 comprises a flexible cloth material configured in a tubular shape. In some embodiments, the flexible cloth material may be sewn, stitched, glued, and/or otherwise bound to maintain the tubular shape and/or an at least partially flattened tubular shape. In this embodiment, the links 202 comprise a rivet 211 fastened through the tube 210 to maintain provide stress relief to a stitch 214 of the first interface 204.

Referring now to FIG. 3, a cut-away orthogonal top view of the first interface 204 is shown. In this embodiment, an elastic receiver 216 may comprise an elastic tubular member, such as, but not limited to, a rubber tube. In some embodiments, the receiver 216 may be substantially enveloped by material of the tube 210 by passing an end of the tube 210 through a central passage of the receiver 216 and folding the material over the receiver 216 to cover the exterior of the receiver 216 and longitudinally overlap and envelope at least a portion of the material within the receiver 216 and/or the material passed fully through the receiver 216.

Referring now to FIG. 4, a cut-away orthogonal top view of the second interfaces 206 is shown. In this embodiment, the second interface 206 comprises a magnet 208 encased within the tube 210. The magnet 208 may generally be captured within an interior compartment 218 of the tube 210. In this embodiment, the compartment 218 is formed by inserting the magnet 208 into an open end of the tube 210, closing the end of the tube with a stitch 214, and segmenting the tube 210 using a stitch 214 located along the length of the tube 210 between the magnet 208 and the first interface 204. In this embodiment, the magnet 208 is generally restrained to a location substantially near an end of the tube 210.

In operation, the wearable device 100 may be assembled by inserting an end of the arms 134 into the central passage of the receiver 216, thereby tethering the links 202 to the eyeglasses frame 128. Next, above-described loop may be formed by bringing the magnets 208 into close proximity of each other until a magnetic connection between the magnets 208 is self-sustaining, thereby joining the links 202 to each other. In some cases, the loop formed by the wearable device 100 may be used to suspend the wearable device from an object such as a hook. In other cases, the loop formed by the wearable device 100 may be used to encircle a neck of a wearer of the wearable device 100. Notably, the magnetic connection between the links 202 allows for convenient disassembly of the loop of the wearable device. In some cases, while the loop of the wearable device 100 is encircled around an object, such as a neck of a wearer of the wearable device 100, the wearable device 100 may be removed from the neck by pulling the links 202 away from each other with force sufficient to overcome the magnetic connection between the second interfaces 206, thus allowing removal of the wearable device 100 from the neck without having to remove the loop by longitudinal displacement of the loop along the length of the neck and/or head. Similarly, the wearable device may be caused to encircle the head and/or neck of a wearer of the wearable device 100 by first placing the eyeglasses frame 128 into a traditional visually assistive position (i.e. supported by at least one of the bridge 132 and/or arms 132) and thereafter moving the second interfaces 206 into engagement with each other. It will be appreciated that alternative methods of assembly of the wearable device 100, disassembly of the wearable device 100, and/or suspension of the wearable device 100 are also within the scope of this disclosure. For example, in some cases, the eyeglasses frame 128 need not be positioned as described above before joining the second interfaces 206, but rather, the wearable device 100 may be suspended by grasping the links 202 and forming the loop around the neck and/or head while the eyeglasses frame 128 simply remains suspended by the first interfaces 204.

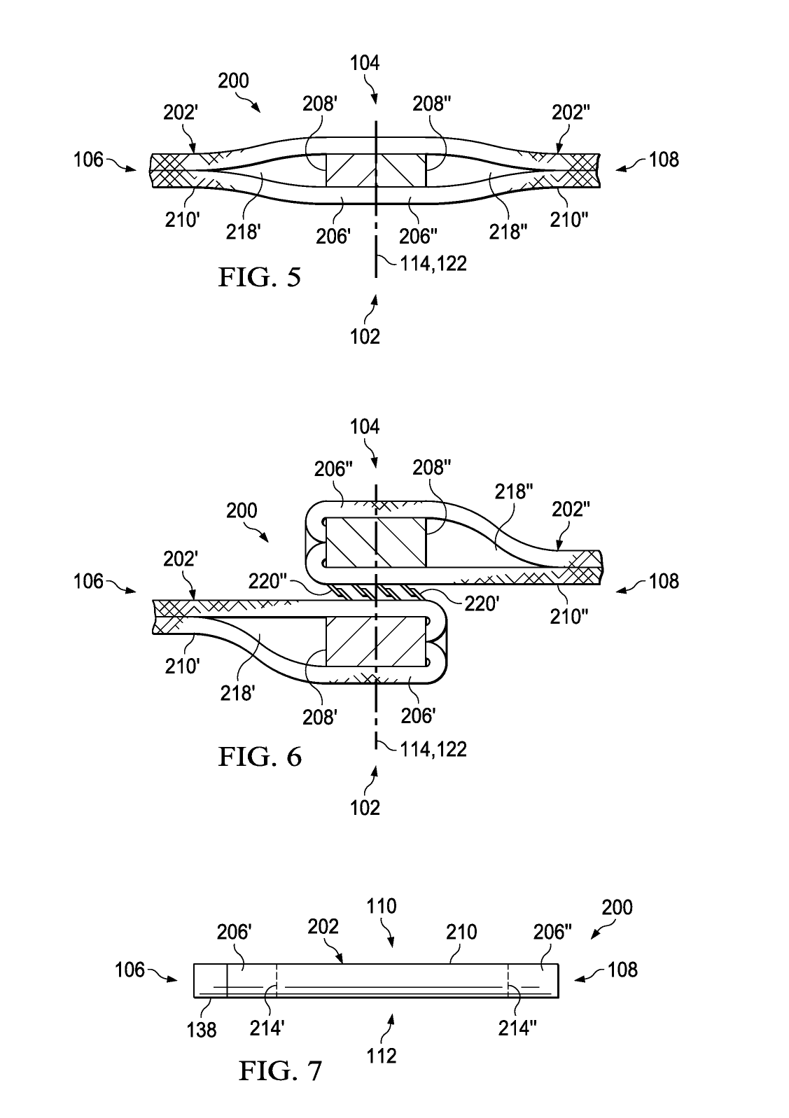

Referring now to FIG. 5, a cut-away orthogonal top view of a portion of a retention system 200 according to an alternative embodiment of the disclosure is shown. In this embodiment, the second interface 206 is configured to provide an end-to-end magnetic connection between the links. In this embodiment, the magnets 208 may be received within the tube 210 and simply glued into place. Alternatively, the magnets 208 may be bound by stitches or encased within an additional component affixed to the end of the link 202. In this embodiment, the tubes 210 may appear to be a continuous and/or unitary member as a result of the substantial abutment of tube 210 material.

FIG. 6 is a cut-away orthogonal top view of a portion of a retention system 200 according to another alternative embodiment of the disclosure. In this embodiment, directional elements 220 may be provided between the magnets 208 to selectively provide additional resistance to inadvertent separation of the magnetic connection between the second interfaces 206 as a result of pulling the links 202 away from each other in a direction along their lengths. The directional elements may comprise plastic fibers, a directional cloth fiber treatment, appropriate selection and orientation of tubular material with inherent directional protrusion features, and/or any other suitable manner of providing directionally resistive engagement of the second interfaces 206.

FIG. 7 is an orthogonal right view of a retention system 200 according to another alternative embodiment of the disclosure. In this embodiment, the retention system 200 comprises only a single link 202. In this embodiment, the retention system 200 may be configured for connection to the eyeglasses frame on one end by a first interface 204 and a second end by a second interface 206. In some embodiments, the second interface 206 may be configured to magnetically connect to a magnetic and/or sufficiently ferrous component 138 of the eyeglasses frame 128.

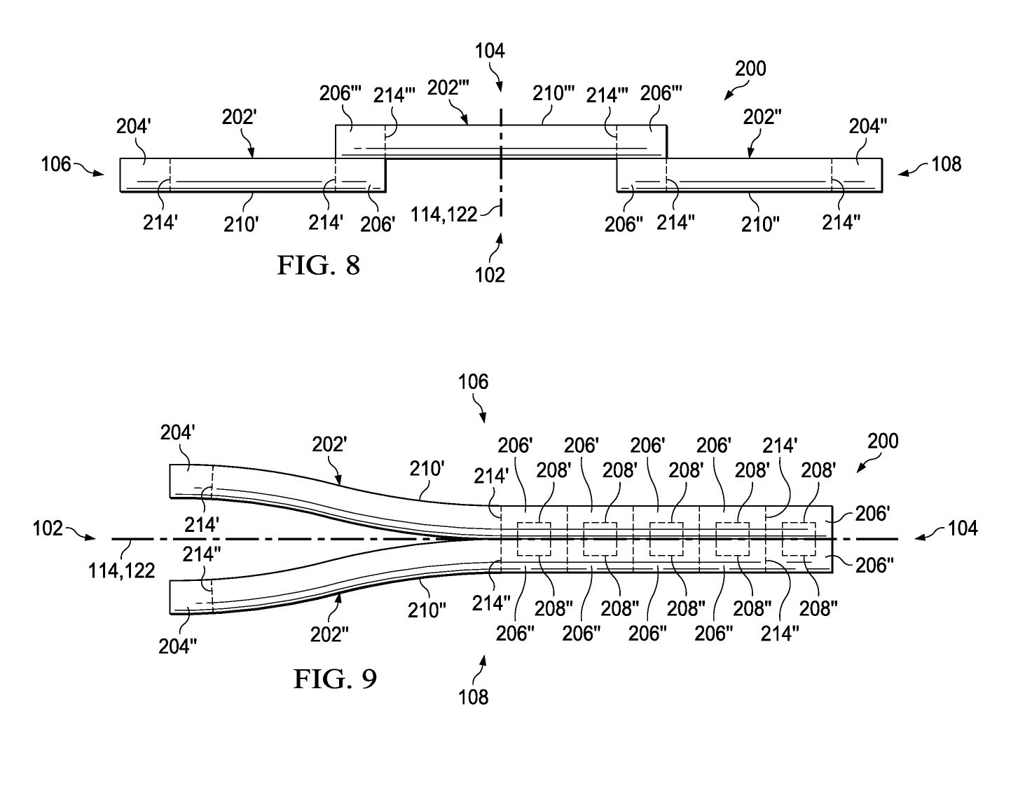

FIG. 8 is an orthogonal top view of a retention system 200 according to another alternative embodiment of the disclosure. In this embodiment, the retention system 200 comprises three links 202. In this embodiment, the intermediate link 202′″ comprises two second interfaces 206 configured for magnetic connection to the second interfaces of the adjacent links 202.

FIG. 9 is an orthogonal top view of a retention system 200 according to another alternative embodiment of the disclosure. In this embodiment, the retention system 200 comprises two links 202, each comprising a plurality of second interfaces 206 along the length of the tube 210. In this embodiment, the plurality of second interfaces 206 may prevent inadvertent separation of the two links 202 and/or may provide for selectively tensioning the eyeglasses frame 128 against a wearer of the wearable device 100.

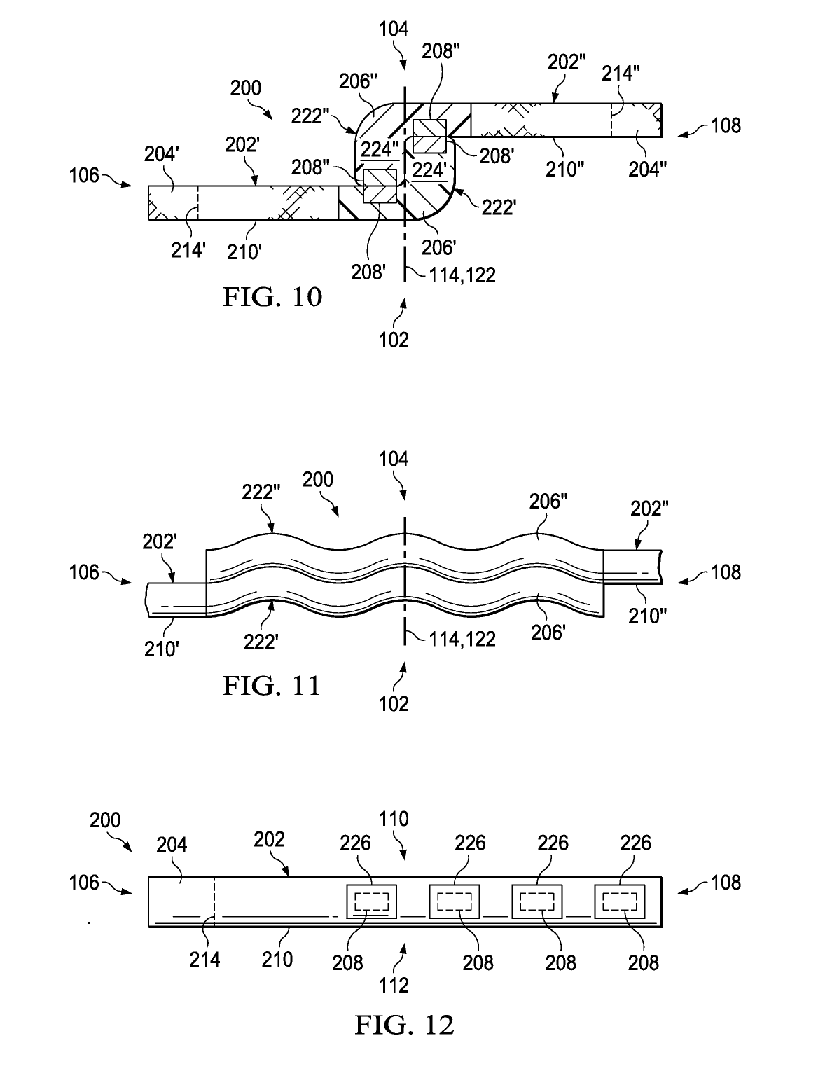

FIG. 10 is a cut-away orthogonal top view of a retention system 200 according to another alternative embodiment of the disclosure. In this embodiment, the second interface 206 comprises complementary structures 222. In this embodiment, the magnets 208 are disposed within the complementary structures 222 and the complementary structures 222 comprise overlapping protrusions 224 configured to provide additional resistance to inadvertent separation of the magnetic connection between the second interfaces 206 as a result of pulling the links 202 away from each other in a direction along their lengths.

FIG. 11 is an orthogonal top view of a portion of a retention system 200 according to another alternative embodiment of the disclosure. In this embodiment, the second interfaces 206 comprise a complementary structure 222 comprising an undulating exterior. In this embodiment, the complementary structure 222 may comprise magnets 208, ferrous material, and/or may itself be a magnet 208 and/or a ferrous material. It will be appreciated that the uniform undulating exterior may provide a length adjustment of the above-described loop selectively formed by the eyeglasses frame 128 and the retention system 200. Further, the undulating exterior may additionally provide additional resistance to inadvertent separation of the magnetic connection between the second interfaces 206 as a result of pulling the links 202 away from each other in a direction along their lengths.

FIG. 12 is an orthogonal left schematic view of a portion of a retention system 200 according to another alternative embodiment of the disclosure. In this embodiment, the link 202 may comprise externally accessible pockets 226 into which magnets 208 and/or ferrous material may be selectively inserted or removed. This embodiment may allow customization of a length of the above-described loop, selective tensioning of the eyeglasses frame 128 against a wearer of the wearable device 100, and/or the ability to customize the overall length of the link 202 by selecting a pocket at a desired length and cutting off a remainder of the link 202.

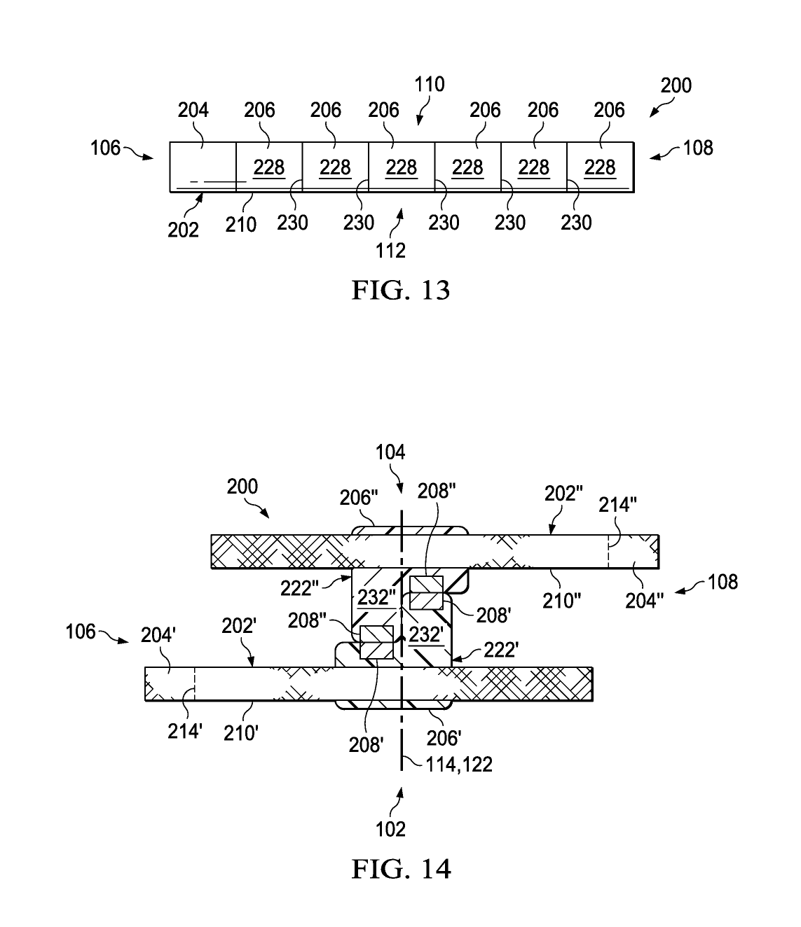

FIG. 13 is an orthogonal left view of a portion of a retention system 200 according to another alternative embodiment of the disclosure. In this embodiment, the link 202 comprises a plurality of compartments 228 within the interior of the tube 210. The compartments 228 are selectively segregated from each other by separators 230, such as hook and loop type fastener material affixed to the interior of the tube 210. In this embodiment, one or more magnets 208 may be selectively located within one or more compartments 229 to provide customization of the above-described loop size, tensioning, and/or overall link 202 length.

FIG. 14 is a cut-away orthogonal top view of a retention system 200 according to another alternative embodiment of the disclosure. In this embodiment, the second interface 206 is movable along a length of the link 202. In this embodiment, the magnet 208 may be housed within a slider 232 that comprises an external structure substantially similar to the complementary structure 222. This embodiment provides both a variable tension and/or loop size as well as additional resistance to inadvertent separation of the magnetic connection between the second interfaces 206 as a result of pulling the links 202 away from each other in a direction along their lengths.

In alternative embodiments of the wearable device 100, a portion of the links 202 themselves may comprise a flexible cloth material, a woven material, a braided material, a multi-fiber material, and/or any other suitable material into which one or more fibers and/or portions of the material comprise at least one of magnetic material and/or ferrous material integrated therein. Accordingly, in some embodiments, a link 202 may comprise a cloth-like material with inherent and/or integrated magnetic connection capabilities for in combination with and/or to the exclusion of other magnetic connection capabilities disclosed herein.

While the disclosure generally explains the retention system 200 as being configured for use with eyeglasses frame 128, in alternative embodiments, the retention system 200 may be utilized and/or configured for use with any other device, wearable or not. Further, while the retention system 200 is generally explained as being configured for use with the head and/or neck of a user, in alternative embodiment, the retention system 200 may be utilized and/or configured for use with any other support structure around which a loop may be placed.

It will be appreciated that the links 202 may be configured in a variety of designs and shapes while maintaining the above-described functionality. In some embodiments, the magnets 208 may comprise neodymium and/or may be encased in a twill material. The magnets 208 may comprise any suitable shape, such as, but not limited to, round, rectangular, and/or oval. In some cases, the magnets 208 may simply be adhered to an exterior of a link 202. In some embodiments, the links 202 may comprise fabric, neoprene, plastic, and/or any other suitable material. In some embodiments, the tubes 210 may comprise material cut into 2.5 inch by 18 inch strips that are subsequently folded and sewn. In some embodiments, the elastic receiver 212 may comprise latex rubber and the receiver may be about 1 inch in length. In some embodiments, the rivets may comprise 9.2 mm alloy rivets and the rivets may comprise decorative embellishments.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{I}, and an upper limit, Rᵤ, is disclosed, any number falling within the range is specifically disclosed. In particular, the following numbers within the range are specifically disclosed: R=R_{I}+k*(Rᵤ−R_{I}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Unless otherwise stated, the term “about” shall mean plus or minus 10 percent. Of the subsequent value. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. A wearable device, comprising:
a first object; and
a retention system comprising a first link comprising a first interface and a second interface;
wherein the first interface is configured to selectively mechanically couple the first link to the first object and wherein the second interface is configured to selectively join the first object and the retention system in a loop via a magnetic connection.

2. The wearable device of claim 1, the retention system further comprising:
a second link comprising a first interface and a second interface;
wherein the first interface of the second link is configured to selectively mechanically couple the first link to the first object and wherein the second interface of the second link is configured to magnetically connect to the second interface of the first link.

3. The wearable device of claim 1, wherein the first object is an eyeglasses frame.

4. The wearable device of claim 1, wherein the first link comprises a tube.

5. The wearable device of claim 1, wherein the first interface comprises an elastic receiver.

6. The wearable device of claim 1, wherein the second interface comprises a magnet.

7. The wearable device of claim 1, wherein the second interface comprises a ferrous material.

8. The wearable device of claim 1, wherein the first link comprises a cloth material sewn to form a tube and wherein a magnet of the second interface is captured within an internal compartment of the tube.

9. The wearable device of claim 1, wherein the second interface comprises a magnet that is movable along a length of the first link.

10. A retention system, comprising:
a first link comprising a mechanical interface and a magnetic interface; and
a second link comprising a mechanical interface and a magnetic interface;
wherein the mechanical interface of the first link and the mechanical interface of the second link are each configured for selective connection to a wearable device and wherein the magnetic interfaces are configured for selective connection to each other.

11. The retention system of claim 10, wherein at least one of the mechanical interfaces comprises an elastic receiver.

12. The retention system of claim 10, wherein at least one of the magnetic interfaces comprises a magnet.

13. The retention system of claim 10, wherein at least one of the magnetic interfaces comprises a ferrous material.

14. The retention system of claim 10, wherein the wearable device is an eyeglasses frame.

15. The retention system of claim 10, wherein the first link and the second link are configured to allow magnetic connection to each other at a plurality of locations along a length of at least one of the first link and the second link.

16. The retention system of claim 10, further comprising:
a third link comprising two magnetic interfaces, the two magnetic interfaces of the third link being configured for magnetic connection to the magnetic interfaces of the first link and the second link.

17. The retention system of claim 10, wherein at least one of the first link and the second link comprise a tube configured to carry the mechanical interface and the magnetic interface.

18. The retention system of claim 10, wherein the first link and the second link comprise complementary structures selectively joined together upon connection of the magnetic interfaces to each other and wherein the complementary structures are configured to resist separation of the magnetic interfaces.

19. A wearable device, comprising:
an eyeglasses frame comprising a first arm and a second arm;
a first link, comprising:
a first mechanical interface comprising a first elastic receiver, the first mechanical interface being configured for mechanically coupling the first link to the first arm by receiving the first arm into the first elastic receiver; and
a first magnetic interface comprising a first magnet; and
a second link, comprising:
a second mechanical interface comprising a second elastic receiver, the second mechanical interface being configured for mechanically coupling the second link to the second arm by receiving the second arm into the second elastic receiver; and
a second magnetic interface comprising a second magnet, the second magnetic interface being configured for magnetically coupling the second link to the first link by magnetically connecting the second magnet to the first magnet.

20. The wearable device of claim 19, wherein a length of a loop comprising the eyeglasses frame, the first link, and the second link is adjustable.
